(19) United States
(12) Patent Application Publication
(10) Pub. No.: US 2007/0194564 A1
(43) Pub. Date: Aug. 23, 2007

(54) TRAILER AND METHOD OF ASSEMBLY

(76) Inventors: Bernard F. Garceau, Vandalia, MI (US); Jon M. Smith, Goshen, IN (US)

Correspondence Address: HAHN LOESER & PARKS, LLP, One GOJO Plaza, Suite 300, AKRON, OH, 44311-1076, US

(21) Appl. No.: 11/675,999

(22) Filed: Feb. 16, 2007

Related U.S. Application Data
(60) Provisional application No. 60/766,908, filed on Feb. 17, 2006.

(51) Int. Cl. B62D 63/06; B21K 21/16; B62D 25/20

(52) U.S. Cl. 280/789; 296/184.1; 29/401.1

(57) ABSTRACT

A trailer and method of assembling a trailer is disclosed. A trailer or motor vehicle may include a frame having fabricated beams. The beams generally include a web section and a pair of opposing flanges. The flanges may be I-shaped or T-shaped, and include web-receiving slots. The flanges may also include obtuse ends along the flange portions thereof, which may also include recesses for cross-member securing fasteners. Top and bottom portions of the web are inserted into the web-receiving slot of a flange and secured therein by a plurality of fasteners. The fasteners for may comprise self-piercing rivets. Because the beams maybe assembled solely with fasteners and without welds, the web and flanges may be pre-coated to provide a finished beam upon assembly. Consequently, the entire frame may be assembled with fasteners, and consequently, may be shipped in pieces and assembled with fasteners at a remote location.

This application claims priority to provisional application Ser. No. 60/766,908, filed Feb. 17, 2006, the disclosure of which is hereby incorporated by reference.

### FIELD OF THE INVENTION

The present invention relates to frames for towed trailers and motor vehicles, including without limitation recreational vehicles (RV's), utility trailers, and the like (hereinafter collectively “trailers”). More specifically, the present invention relates to trailer frames that include improved main beams that exhibit improved strength-to-weight properties that can be assembled with fasteners, and trailer frames that may be shipped in pieces and assembled remotely with fasteners.

### BACKGROUND OF THE INVENTION

Trailers commonly operate under severe conditions, which include being exposed to heavy and dynamic loads for hundreds of thousands of miles over their lifetimes. Dynamic loading includes impact loads and cyclic loads. Consequently, a trailer should be both strong and fatigue resistant. Further, a trailer should resist the elevated loads that arise when cyclical loading occurs at a natural frequency.

Prior art trailer frames are generally made of steel or aluminum. Steel is generally used in lieu of aluminum to provide improved strength capabilities for more demanding applications. However, steel beams are heavier and consequently reduce the trailer's available payload capacity. Prior art steel beams generally comprise either standard rolled I-beams or I-beams welded together from steel plates and sheets. To reduce weight and improve payload capacity, aluminum may be used in lieu of steel. However, it would be desirable to use steel for its high-strength properties while still reducing the weight of the assembled beam (i.e., providing an improved strength-to-weight ratio). Likewise, it would also be desirable to reduce the weight of aluminum trailer beams and improve the strength-to-weight ratio of such beams.

Prior art trailer frames are generally welded together for strength and structural integrity. However, welding requires a significant amount of time and expertise, adds weight, and is rather costly. Fasteners, such as bolts and screws, have been used to join main beams with limited success, primarily because fasteners are susceptible to shearing and unfastening from vibrations arising under normal dynamic trailer operation. Additional steps may be taken to prevent unfastening, such as welding the nut to the beam, with the consequence of adding manufacturing time, weight, and cost to the beam.

Prior art trailer frames are generally assembled prior to shipment. Consequently, the assembled frames may be large and bulky, and difficult to ship, which results in extending shipping time and increased costs. Therefore, it would be desirable to provide a trailer frame that could be more easily shipped. More specifically, it would be desirable to provide a trailer that could be shipped unassembled for remote assembly. The location could be that of a customer or a satellite operation of the manufacturer for more direct sales and delivery. By shipping the frame unassembled, shipping difficulties could be reduced if not eliminated. Further, by shipping components unassembled, the receiver is able to modify or customize the frame as desired for a specific use prior to assembly.

Accordingly, there is a need for a trailer frame main beam that provides improved strength-to-weight properties. Further, there is a need for a trailer frame that is easy to assemble and capable of being shipped and assembled remotely.

### SUMMARY OF THE INVENTION

One embodiment of the present invention includes a trailer comprising: a frame having a first main beam laterally spaced from a second main beam, each beam extending longitudinally between a front end and a rear end of the trailer and having a web, a top flange attached to a top end of the web, and a bottom flange attached to a bottom end of the web, at least one of the top and bottom flanges comprising a pair of outer transverse members and a web-receiving slot, the top end or bottom end of the web being located within the slot; and a wheel axle secured to the frame.

Another embodiment of the present invention includes a trailer comprising: a frame having a first main beam laterally spaced from a second main beam, each beam extending longitudinally between a front end and a rear end of the trailer and having a web, a top flange attached to a top end of the web, and a bottom flange attached to a bottom end of the web, each flange being monolithic and comprising a laterally extending outer member having two edges, a return member extending laterally from each outer member edge, a web constraining member extending from each return member in a direction away from the outer member, and a web receiving slot being defined between the web constraining members, the top end of the web being located within the web-receiving slot of the top flange and the bottom end of the web being located within the web-receiving slot of the bottom flange; and, a wheel axle secured to the frame.

Yet another embodiment of the present invention includes a trailer comprising: a frame comprising a plurality of longitudinally extending beams laterally spaced from one another, each beam comprising a plurality of components fastened to one another, each component being pre-finished in a pre-fastened state, the components comprising a web, a top flange attached to a top end of the web, and a bottom flange attached to a bottom end of the web, at least one flange being monolithic and comprising a laterally extending outer member having two edges, a return member extending laterally from each outer member edge, a web constraining member extending from each return member in a direction away from the outer member, and a web receiving slot being defined between the web constraining members, the top or bottom end of the web being located within the slot; and, a wheel axle secured to the frame.

Still another embodiment of the present invention includes a method of forming a trailer comprising the steps of: providing a pair of pre-coated main beams as recited in claim 1; providing a plurality of pre-coated cross-members; providing a wheel axle; transporting to a remote location the main beams, the cross-members, and the axle from one or more originating locations; and, assembling the trailer at the remote location by attaching the plurality of cross-members and the wheel axle to the pair of main beams.

Another embodiment of the present invention includes a method of forming a trailer comprising the steps of: assembling at least one main beam by providing a plurality of pre-finished monolithic components, the pre-finished monolithic components comprising a web, a top flange attached to a top end of the web, and a bottom flange attached to a bottom end of the web, at least one flange being monolithic and comprising a laterally extending outer member having two edges, a return member extending laterally from each outer member edge, a web constraining member extending from each return member in a direction away from the outer member, and a web receiving slot being defined between the web constraining members; inserting the web into the web-receiving slot of the at least one flange; and, fastening the web to the at least one flange with a plurality of fasteners and without welding.

### BRIEF DESCRIPTION OF THE DRAWINGS

The present invention may be better understood when making reference to the accompanying drawings, wherein:

FIG. 1 is a perspective view of the trailer assembly of the present invention;

FIG. 2 is a perspective view of the frame assembly of the trailer shown in FIG. 1;

FIG. 3 is a top view of the frame assembly shown in FIG. 2;

FIG. 4 is a perspective view of a portion of the frame assembly shown in FIG. 2;

FIG. 5 is a perspective view of the main beam of the frame assembly shown in FIG. 2;

FIG. 6 is a cross-sectional view of the main beam shown in FIG. 5;

FIG. 7 is a cross-sectional view of a flange of the main beam shown in FIG. 6;

FIG. 8 is a side view of another embodiment of the web section of the main beam shown in FIG. 5;

FIG. 9 is a perspective view of the embodiment shown in FIG. 8;

FIG. 10 is a side view of the cross-member of the frame assembly shown in FIG. 2;

FIG. 11 is a perspective view of the cross-member of the frame assembly shown in FIG. 2;

FIG. 12 is a perspective view of the outrigger of the frame assembly shown in FIG. 2;

FIG. 13 is a side view of the outrigger shown in FIG. 12;

FIG. 14 is an end view of the outrigger shown in FIG. 12;

FIG. 15 is a perspective view of a front end portion of the frame assembly shown in FIG. 2;

FIG. 16 is a perspective view of the coupler of the frame assembly shown in FIG. 2;

FIG. 17 is a perspective view of the A-frame of the frame assembly shown in FIG. 2;

FIG. 18 is a perspective view of the A-frame of the frame assembly shown in FIG. 2;

FIG. 19 is a perspective view of a rear end portion of the frame assembly shown in FIG. 2;

FIG. 20 is a perspective view of axle mount of the frame assembly shown in FIG. 2; and,

FIG. 21 is a perspective view of wheel/axle assembly of the frame assembly shown in FIG. 2.

### DETAILED DESCRIPTION OF THE DRAWINGS

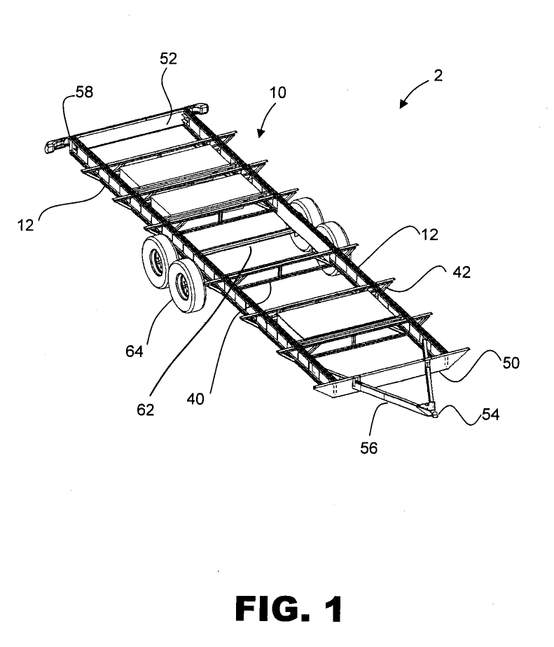

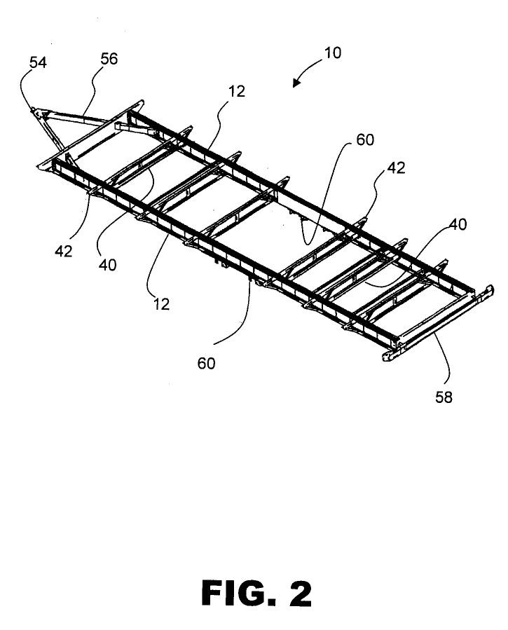

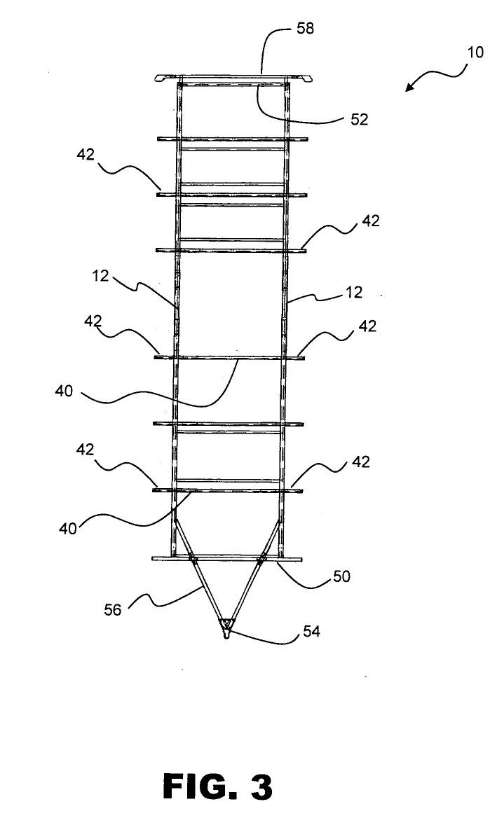

Referring to FIGS. 1-3, the present invention generally comprises a trailer 2 having trailer frame 10. The trailer frame 10, or any embodiment thereof, may form part of a towed trailer or a motor vehicle. Consistent therewith, the trailer frame may be used on a recreational vehicle (RV), or may be used to haul any payload, including without limitation boats, motorcycles, metal products, or machinery. Because trailers, by nature, withstand dynamic, and at times heavy, loading for hundreds of thousands of miles, trailer frame design is very important. Further, there is a need and market for trailers that can exhibit high strength and toughness, while maximizing payload capacity.

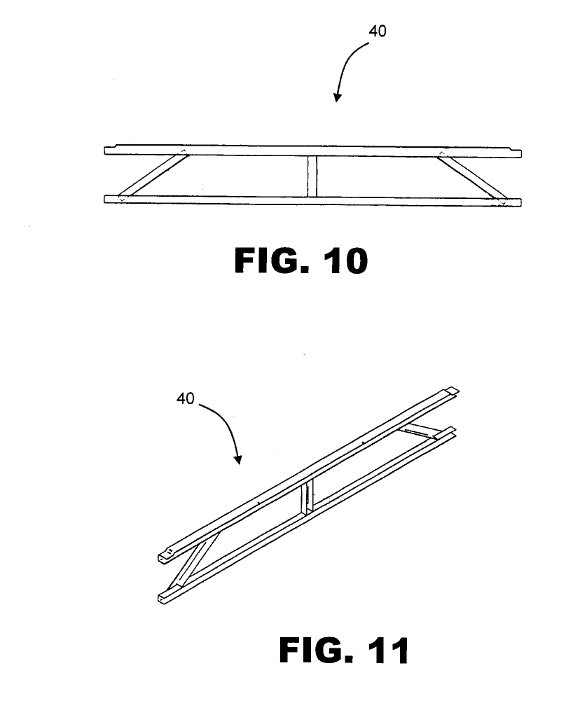

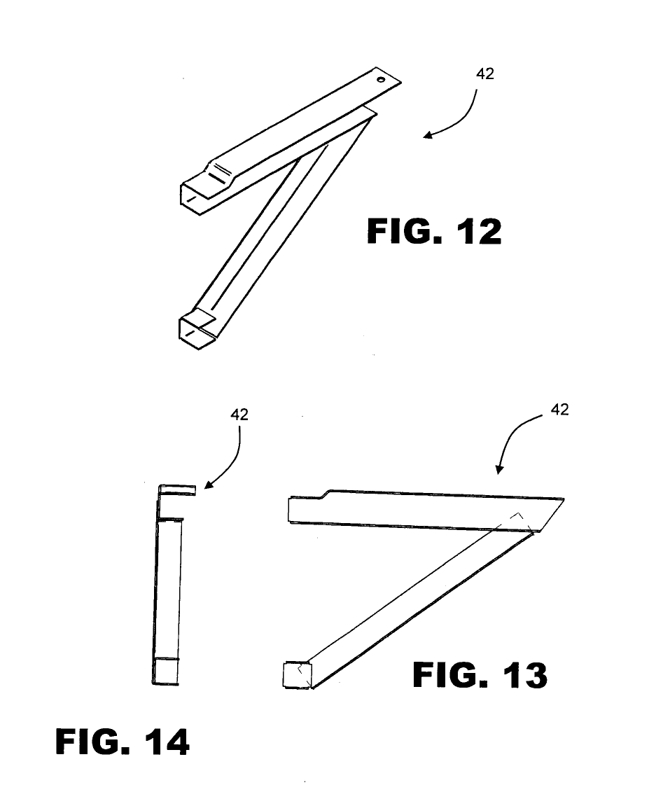

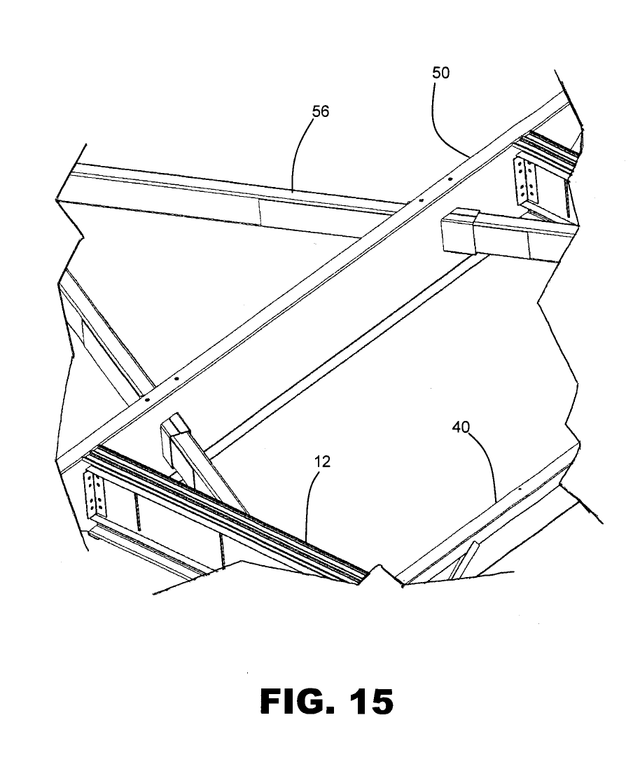

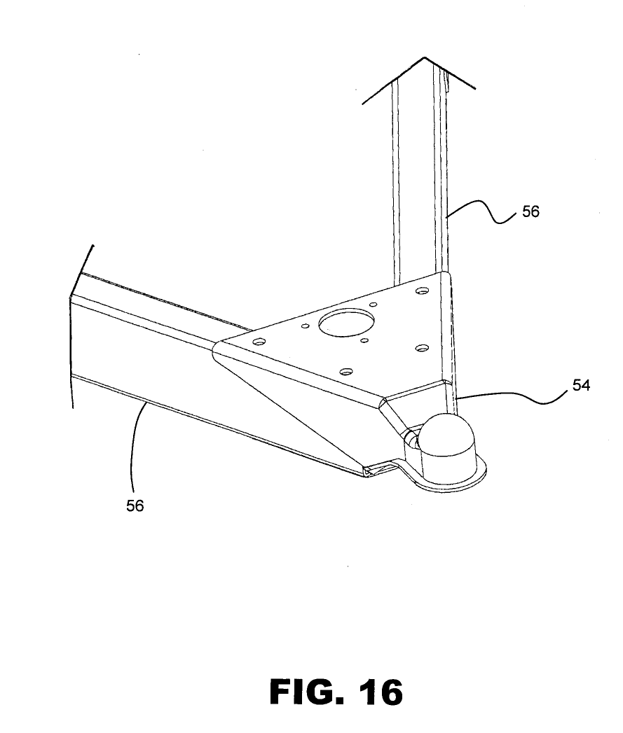

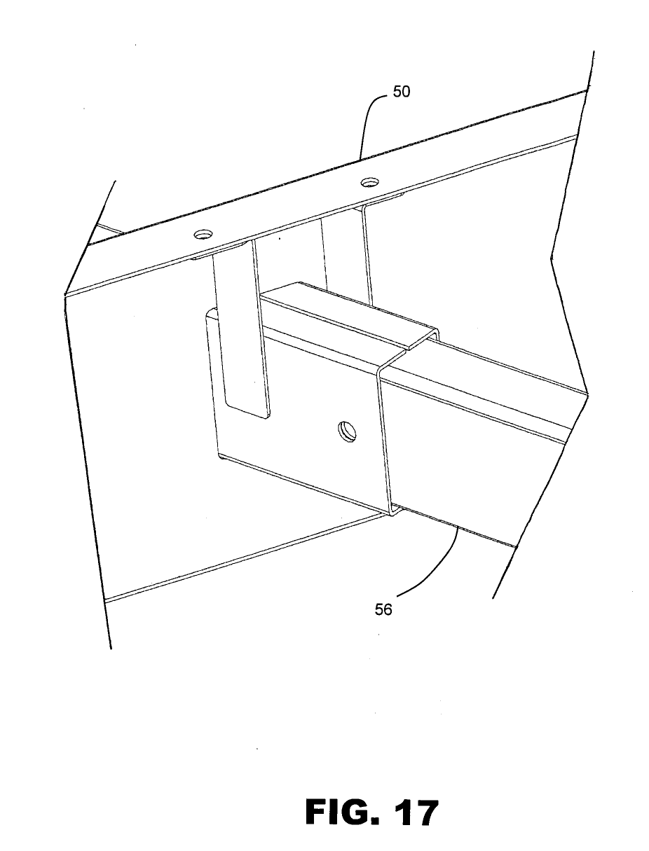

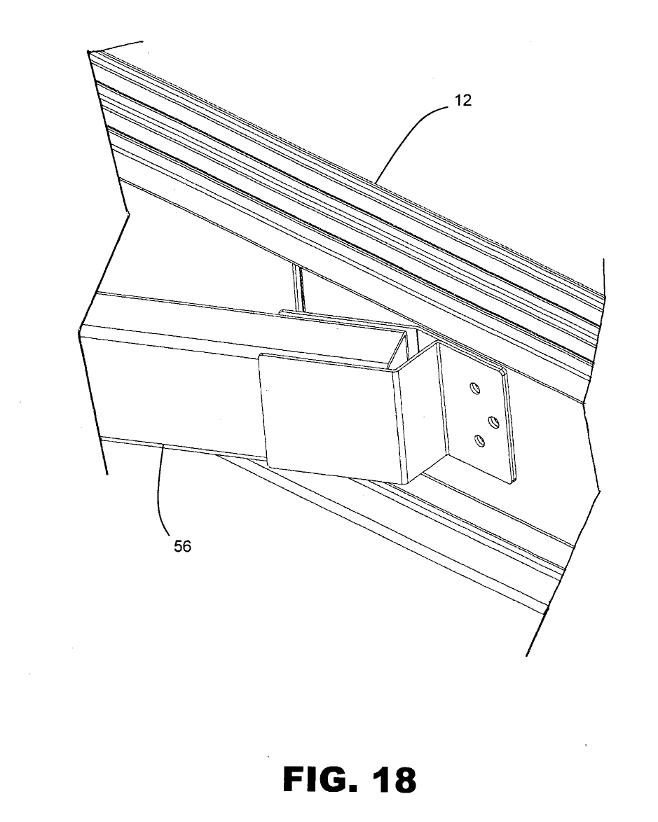

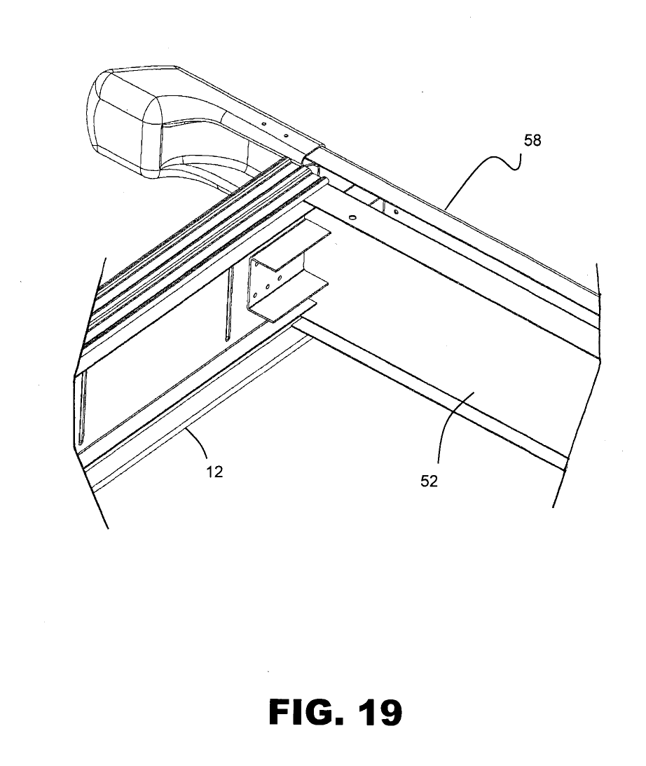

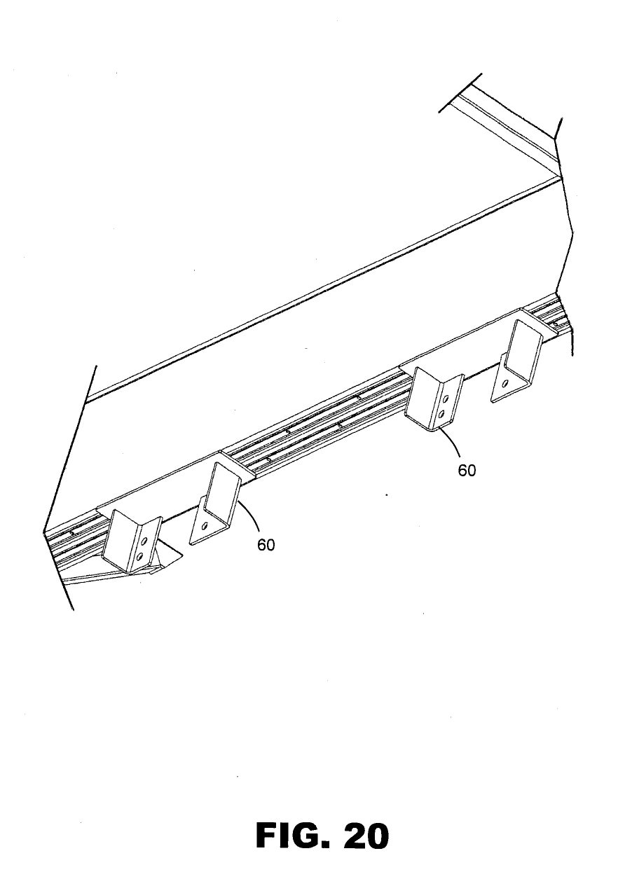

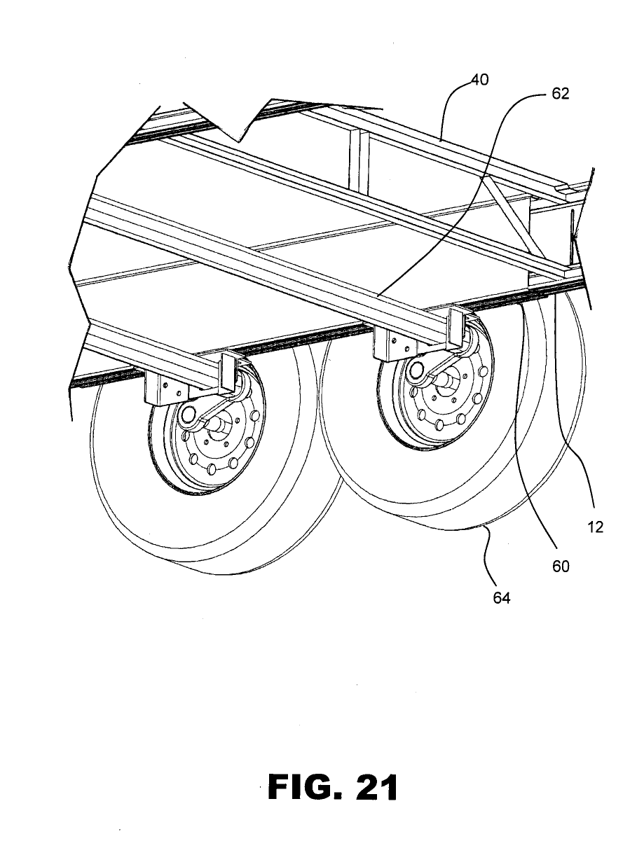

Trailer frame 10 generally comprises main beams 12, which generally extend from the front to the rear of the trailer. In one embodiment, the frame includes a pair of main beams; however, it is contemplated that any number of main beams may be used for a desired application. The beams may be of any height or length as desired for the specific application. In one embodiment, the beam height may be approximately between seven inches (7″) and ten inches (10″) and the beam length between twelve feet (12′) and forty-five feet (45′). It is contemplated that the beams may be continuous along their length, or may comprise multiple beams joined to form a longer beam. In addition to the main beams 12, the trailer frame 10 may include cross-members 40 and/or outriggers 42, although it is contemplated and acknowledged that neither may be used nor required in a variety of applications. Cross-members 40 are structural members that extend along their length to connect a pair of main beams 12. Cross-members 40 may also extend through a hole or opening in a beam and continue in an outwardly direction from the trailer frame 10. In the alternative, separate members called outriggers 42 may extend from exterior side of the main beam (i.e., extend from the main beam in an outwardly direction from the trailer frame). Cross-members 40 and outriggers 42 may each provide support and a location for securing flooring or other structure placed atop the frame 10. Cross-members 40 and outriggers 50 may each be assembled from a plurality of members or may be comprise a single member, each of which may be extruded, stamped, cold-formed, hot-formed, or roll-formed. Depending on the application, the trailer 2 and frame 10 may also include front 50 and rear end caps 52, a coupler 54 and adjoining A-frame 56, a rear bumper 58, an axle mount 60, and an axle 62 with tire/wheel assembly 64, each of which is shown in more detail in FIGS. 10-21.

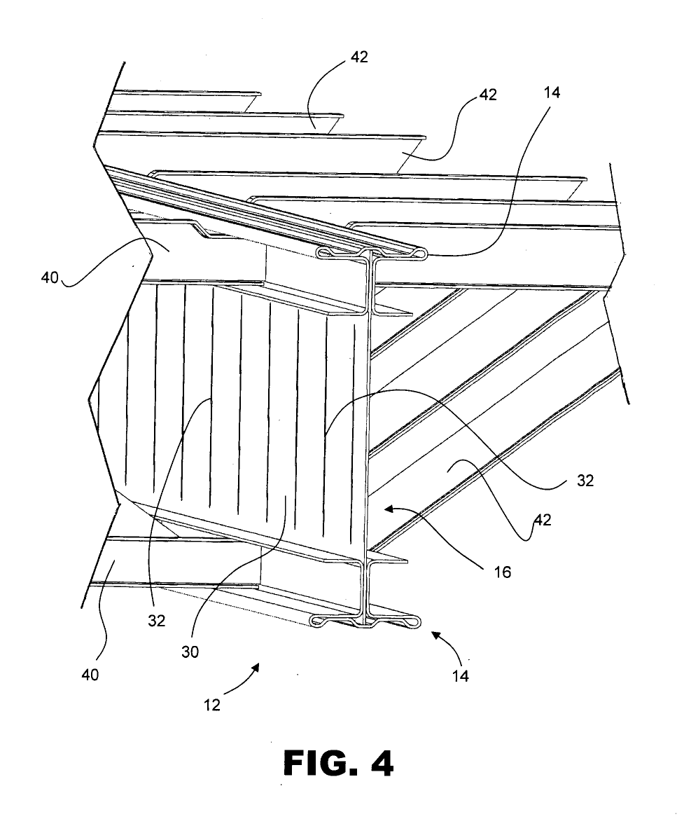

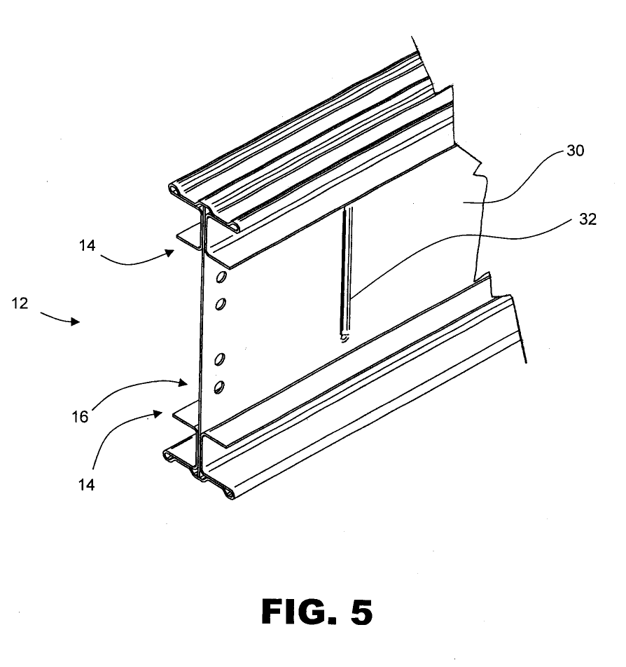

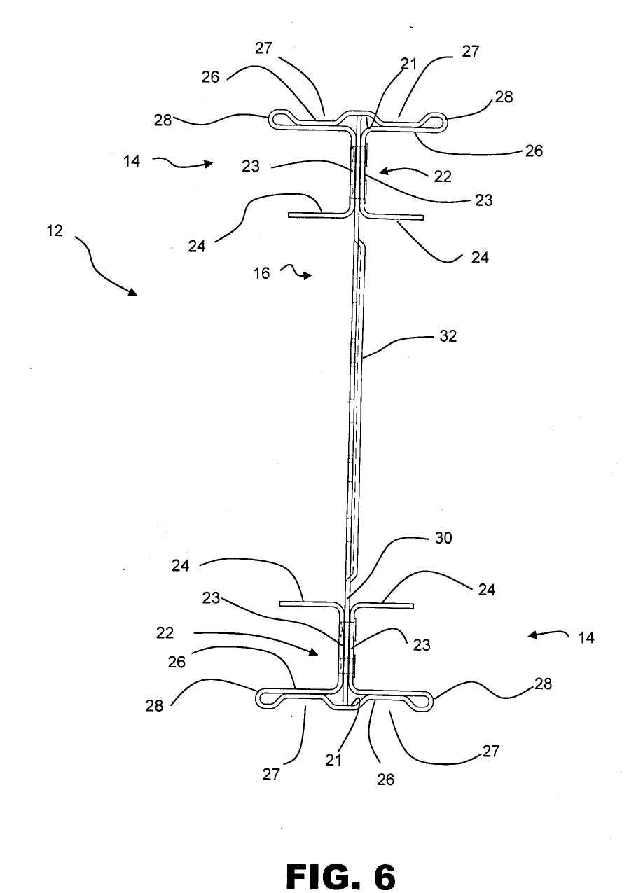

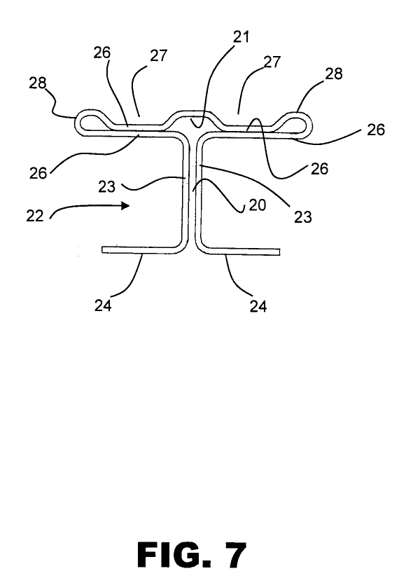

Referring to FIGS. 4-7, in one embodiment, main beams 12 are each formed from a pair of flanges 14 and a web 16, each extending longitudinally along the length of a beam 12. In one embodiment, flanges 14 and web 16 are continuous (non-spliced) along the length of the beam. However, it is contemplated that one or more of the flanges 14 and web 16 may be non-continuous (or spliced) to provide the desired length for beam 12. Flanges 14 may be of the same design or different. In one embodiment, the flanges 14 generally have an I-shaped cross-section and are formed from a continuous (non-spliced) sheet of steel. This allows the use of thinner materials for the flanges 14 and the web 16, which reduces the weight of main beam 12. In another embodiment, flanges 14 are generally T-shaped. It is also contemplated that the flanges may be of any shape, including without limitation C-shaped, U-shaped, S-shaped, or Z-shaped. It is further contemplated that flanges 14 may be formed from any grade of steel and any other material, such as aluminum, by any known means, such as roll-forming, extrusion, hot forming, cold forming, or assembly. It is contemplated that material used to form flanges 14 and web 16 may include laterally extending splices, longitudinally extending splices, or angled splices extending both laterally and longitudinally.

With continued reference to FIGS. 4-7, the I-shaped flanges 14 generally comprise a web-receiving slot 20, a central member 22, a pair of inner transverse members 24, and a pair of outer transverse members 26. The web-receiving slot 20 is located on an inner side (or web side) of the flange 14 for the purpose of accepting a portion of the web 16 for attachment. In one embodiment, the web-receiving slot 20 forms a portion of the central member 22. It is also contemplated that slot 20 may instead extend from the inner members 24. To provide improved structural integrity and support, and to help relieve stress from the fasteners or welds attaching the web to the flange, web 16 extends completely into slot 20 and contacts the opposite end 21 thereof. Flange 14 may be T-shaped, as either of the pair of inner and outer transverse members do not existent.

Central member 22 of the flange 14 connects the pair of outer members 26 to the pair of inner members 24. In one embodiment, the central member 22 includes the web-receiving slot 20 and comprises a pair of extensions 23. The extensions 23 connect one of the pair of outer members 26 with one of the pair of inner members 24. It is contemplated that the central member 22 may comprise only a single extension 23 that extends from each pair of members 24, 26.

The pair of inner members 24 and outer members 26 form the transverse sections of the I-shaped (or I-beam shaped) flange 14. The members 24, 26 increase the bending strength of the main beam 12 by increasing the amount of material further away from the longitudinal axis of the main beam 12. Of the pair of members, the inner members 24 are located closest to the longitudinal central axis of the main beam 12. In other words, the inner members 24 are located on the web-receiving (or inner) end of the flange 14, while the outer members 26 are located closer to the opposing (or outer) end of the flange 14. The inner 24 and outer members 26 extend laterally or transversely from the flange 14, which means that the members may extend perpendicularly from the central member, or at any other non-perpendicular angle therefrom. Generally, each member of each pair 24, 26 extends from an opposite side of the central member 22. Further, each of the pair of members 24, 26 may be symmetric or asymmetric about the length of the central member. In another embodiment, the pair of inner members 24 does not exist, thereby providing a generally T-shaped flange.

Each member of the pair of outer members 26 may include an end 28 opposite the central member that is obtuse, enlarged, or rounded. This obtuse end design provides an increased bending modulus for the main beam 12 and for the flange 14 as it supports a floor or structure and any cross-members 40 attached to the flange 14. Further, the obtuse end 28 reduces damage to and deformation of the material, and thereby allows the flange to be roll-formed or cold formed from stronger materials, such as HSLA (high strength low alloy) steel, which are less able to navigate or form acute ends. The obtuse end 28 generally has a height of approximately three (3) times the thickness of the material used to form the outer transverse members 26 about the obtuse end 28. By using methods such as roll-forming, flange 14 may be formed from a single sheet of material, which may provide a stronger and more consistent structure over one formed from pieces such as by welding and thereby allow the use of thinner materials to provide weight savings. A roll-formed flange 14 provides outer members 26 that extend from the central member 22, about the obtuse end 28, and return to a central location to join the other outer member 26. Along each outer member 26 between the obtuse end 28 and the central member 22 a recess 27 may exist. Recess 27 provides a location to secure a cross-member 40 or outrigger 42 to the flange 14 with a fastener. When a fastener is engaged within recess 27, the head of the fastener may ultimately rests within recess 27 and below an external or top plane of the outer transverse members 26, thereby preventing any interference between the fastener and any flooring or structure extending across external side of outer members 26, or atop/below beam 10.

Web 16, in one embodiment, is formed from a single continuous sheet 30 that may have holes or apertures therein for a variety of uses, including without limitation for allowing cross-members 40 to pass through the beam. To improve the strength of the web 16 and to allow the use lighter gauge materials for the web 16 and flanges 14, the web 16 may include embossments 32. Embossments 32 may extend vertically, or at any other desired angle, along sheet 30. The embossments 32 generate a recess on one side of the web 16, while providing a corresponding raised portion opposite the recess on the other side of the web 16. This improves both bending resistance and strength. The embossments 32 may be spaced at any interval, including without limitation on six-inch (6″) centers. Embossments may be of any width and depth. It is also contemplated that web 16 may include weight-saving holes or apertures, which may include flared or bent edges to provide additional bending resistance and strength (similar to the embossments). The holes and embossments 32 may be formed via stamping, or by any other commercially known means. Further, the top and bottom edges of the web 16, which are adjacent the flanges 14, may also be flared for additional strength and to provide a surface for securing any adjacent flange 14. To form a beam 12, the web 16 is secured to a flange 14. In one embodiment, the web 16 is inserted into a web-receiving slot 20 of a flange 14 and secured. Additional support and relief may be provided to the fasteners or welds securing the web and flange together by inserting the web 16 into the slot 20 until contacting a stop surface 21 (which may be the end of slot 20) within slot 20. In another embodiment, when no web-receiving slot 20 exists, the web 16 is placed adjacent a portion of the flange 14 and secured thereto.

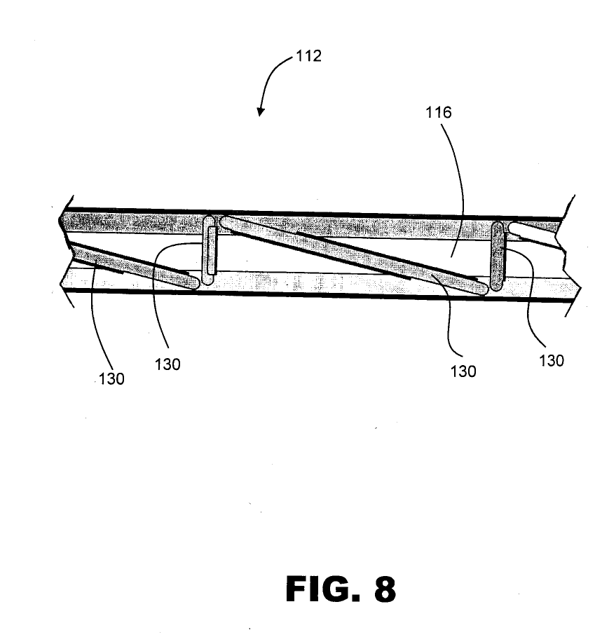

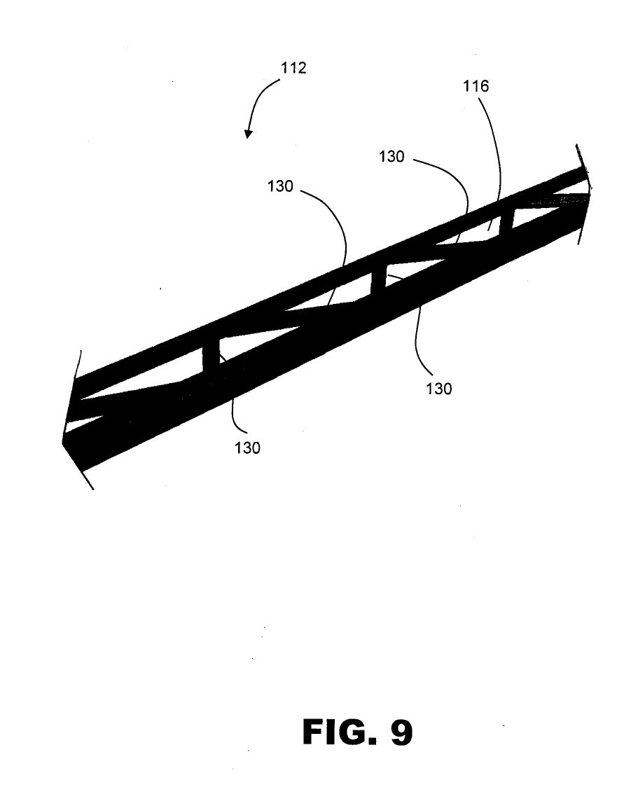

Referring to FIGS. 8-9, in another embodiment, web 116 may comprise a network of truss members 130. The members may extend vertically or at any other angle. The arrangement of truss members may include only vertically extending members, only non-vertically extending (i.e., inclined) members, or any combination thereof. Further, the web 116 may also include, in addition to the truss members 130, sheets or plates of material, which may act as a reinforcing member or a mounting surface. The truss members 130 may be formed from structural angles, tubes, channels, I-beams, or the like, or may be fabricated (roll-formed, broke, bent, or stamped) from material. The truss members 130 are inserted into the web-receiving slots 20 or along another portion of the flange, if no slot 20 exists, and secured thereto.

In the prior art, trailers, trailer frames, and main beams have generally been assembled and joined by welding together the structural members (beams, cross-members, and outriggers). Welding provides strength and structural integrity for resisting heavy and dynamic loads. However, welding adds significant time and weight, which increases costs and reduces the payload capacity of the trailer, and is susceptible to fatigue cracking. The use of fasteners to join the main beams and/or the trailer frame could allow faster and lower cost assembly. Further, fasteners could allow another to assemble the beams and/or frame remotely. In one embodiment, the web is secured to the flange via self-piercing rivets, such as but not limited to Rivnuts® (provided by Böllhoff). The self-piercing rivets 34 tap into one side of the web-receiving slot, through the web, and into or through the opposing side of the slot. The rivets create an anchor or enlarged portion that resists any attempt to remove the rivet. No pre-drilled holes are required and no other mechanisms are required to keep the rivet secured within the web and flange (i.e., prevent removal), such as welds, Loctite®, nuts, and spring washers. This reduces labor, costs, and weight. It is contemplated, however, that other self-piercing or drilling fasteners may be used to secure the web to the flange, as well as welds or other conventional fasteners, such as rivets, screws, nuts and bolts. Any fasteners may be applied as an array of single or multiple fasteners along the length of the flange.

In one embodiment, the main beams 12 (including the flanges 14 and the web 16), cross-members 40, and outriggers 42 are roll-formed from HSLA steel. However, it is contemplated that each may be made from any other commercially available steel or other material, such as aluminum, and may be formed via roll-forming, cold forming, hot forming, extrusion, or stamping. Due to the ability to use fasteners, it is also contemplated that any combination of materials may be used. For example, the web could be made of steel and the flanges made of aluminum, or visa versa. Also, the beams could be made of steel and the cross-members and outriggers made from aluminum, or visa versa. It is contemplated that flanges 14 and web 16 may each be formed from two or more pieces of material and the main beam 12 may include two or more sections that are joined together, via fasteners, welds or any other commercially known means.

Because the trailer frame 10 and beam 12 may be assembled with fasteners, the trailer frame 10 and beams 12 are able to be shipped unassembled from one or more locations to a remote location for assembly. This reduces shipping time and costs, and allows the assembler to make any modifications (customize) to the frame 10, and any components thereof, as desired before or during assembly. Also, when assembling the trailer frame 10 and/or beam 12 solely or primarily with welds, the frame components may be pre-coated. This provides a finished product after assembly is completed. Otherwise, if the frame was to be welded, pre-coating would not be desired since the welds need a clean and uncoated surface for proper penetration, and because the weld itself should also be coated. It is contemplated that any coating may be placed upon any and all frame components, including without limitation galvanizing, e-coating, and painting.

To provide a less bowed trailer under load, portions of the trailer frame 10, including the beams 12, may be arched or curved. The arched or curved portions compensate for any deflection the trailer may experience under load. For instance, if a trailer is a towed trailer and has an axle system centrally located along the trailer, the rear of the trailer is cantilevered and may deflect downward under load. To prevent the rear of the trailer from drooping, the trailer and trailer frame may provide a rear portion that is curved upward, so the deflected trailer appears to be more planar or linear. If the axle system is rearward, the central portion may be arched upward to compensate for any downward deflection. Often, when providing an arch or curve, the beam 12 is cut and welded along a portion of the web. Also, a arched or curved web may be provided and the flange bent or deflected along the arched or curved portion of the web prior to securement thereto.

The foregoing is an illustration of the invention, which is described with respect to specified embodiments, and is not intended as a limitation. Consequently, other modifications or variations to the specific apparatuses and methods described will be apparent to those skilled in the art and will fall within the spirit of the invention and the scope of the following claims.

I claim:

1. A trailer comprising:
a frame having a first main beam laterally spaced from a second main beam, each beam extending longitudinally between a front end and a rear end of the trailer and having a web, a top flange attached to a top end of the web, and a bottom flange attached to a bottom end of the web, at least one of the top and bottom flanges comprising a pair of outer transverse members and a web-receiving slot, the top end or bottom end of the web being located within the slot; and,
a wheel axle secured to the frame.

2. The trailer as recited in claim 1, at least one of the top and bottom flanges further comprising a pair of inner transverse members and a central member connecting the pair of inner members to the pair of outer members.

3. The trailer as recited in claim 2, the central member including the web-receiving slot.

4. The trailer as recited in claim 3, the top and bottom flanges each comprising a pair of outer transverse members, a web-receiving slot, a pair of inner transverse members, and a central member connecting the pair of inner members to the pair of outer members.

5. The trailer as recited in claim 3, the at least one flange being monolithic.

6. The trailer as recited in claim 3, the central member comprising a pair of extensions, each extension connecting one of the pair of outer members with one of the pair of inner members.

7. The trailer as recited in claim 1, at least one of the flanges being substantially I-shaped.

8. The trailer as recited in claim 2, each member of the pair of outer members and each member of the pair of inner members extending in a direction outward the central member.

9. The trailer as recited in claim 8, each member of the pair of outer members returning to the other outer member above the central member.

10. The trailer as recited in claim 9, the at least one flange being monolithic.

11. The trailer as recited in claim 1, each member of the pair of outer members having an obtuse end.

12. The trailer as recited in claim 11, each obtuse end formed by bending a portion of the outer member, each obtuse end having a height at least approximately three-times the thickness of the outer member used to form the obtuse end.

13. The trailer as recited in claim 1, each member of the pair of outer members having a recess that opens in a direction outward the beam.

14. The trailer as recited in claim 1, at least one of the top and bottom flanges being formed from a laterally continuous sheet of material.

15. The trailer as recited in claim 14, at least one of the top and bottom flanges being roll-formed from steel.

16. The trailer as recited in claim 3, at least one of the top and bottom flanges being formed of extruded aluminum.

17. The trailer as recited in claim 1, the web having a plurality of embossments extending in a direction between the top end and bottom end of the web.

18. The trailer as recited in claim 1, the web comprising a plurality of truss members.

19. The trailer as recited in claim 1, the top and bottom flanges each being attached to the main beam with a plurality of fasteners.

20. The trailer frame as recited in claim 19, wherein the fasteners are self-piercing rivets.

21. The trailer frame as recited in claim 1, further comprising a plurality of cross-members connecting the first and second main beams.

22. The trailer frame as recited in claim 21, the plurality of cross-members are attached to the main beams with a plurality of fasteners.

23. The trailer frame as recited in claim 22, where the fasteners are self-drilling screws.

24. A trailer comprising:
a frame having a first main beam laterally spaced from a second main beam, each beam extending longitudinally between a front end and a rear end of the trailer and having a web, a top flange attached to a top end of the web, and a bottom flange attached to a bottom end of the web, each flange being monolithic and comprising a laterally extending outer member having two edges, a return member extending laterally from each outer member edge, a web constraining member extending from each return member in a direction away from the outer member, and a web receiving slot being defined between the web constraining members, the top end of the web being located within the web-receiving slot of the top flange and the bottom end of the web being located within the web-receiving slot of the bottom flange; and,
a wheel axle secured to the frame.

25. The trailer as recited in claim 24, the flanges being secured to the web with fasteners and without welds.

26. A trailer comprising:
a frame comprising a plurality of longitudinally extending beams laterally spaced from one another, each beam comprising a plurality of components fastened to one another, each component being pre-finished in a pre-fastened state, the components comprising a web, a top flange attached to a top end of the web, and a bottom flange attached to a bottom end of the web, at least one flange being monolithic and comprising a laterally extending outer member having two edges, a return member extending laterally from each outer member edge, a web constraining member extending from each return member in a direction away from the outer member, and a web receiving slot being defined between the web constraining members, the top or bottom end of the web being located within the slot; and,
a wheel axle secured to the frame.

27. The trailer as recited in claim 26, the flanges being secured to the web with fasteners and without welds.

28. A method of forming a trailer comprising the steps of:
providing a pair of pre-coated main beams as recited in claim 1;
providing a plurality of pre-coated cross-members;
providing a wheel axle;
transporting to a remote location the main beams, the cross-members, and the axle from one or more originating locations; and,
assembling the trailer at the remote location by attaching the plurality of cross-members and the wheel axle to the pair of main beams.

29. The method of forming a trailer as recited in claim 28, the flanges of the beam being attached to the web of the beam with fasteners and without welds prior to the step of transporting.

30. The method of forming a trailer as recited in claim 29, the plurality of cross-members being attached to the main beams with fasteners.

31. The method of forming a trailer as recited in claim 30, the main beams being assembled with self-piercing rivets and the cross-members being attached to the main beams via self-drilling fasteners.

32. A method of forming a trailer comprising the steps of:
assembling at least one main beam by providing a plurality of pre-finished monolithic components, the pre-finished monolithic components comprising a web, a top flange attached to a top end of the web, and a bottom flange attached to a bottom end of the web, at least one flange being monolithic and comprising a laterally extending outer member having two edges, a return member extending laterally from each outer member edge, a web constraining member extending from each return member in a direction away from the outer member, and a web receiving slot being defined between the web constraining members;
inserting the web into the web-receiving slot of the at least one flange; and,
fastening the web to the at least one flange with a plurality of fasteners and without welding.

33. The method as recited in claim 32, further comprising the steps of:
providing a plurality of the main beams;
providing a plurality of pre-coated cross-members;
providing a wheel axle; and,
assembling the trailer by attaching the plurality of cross-members and the wheel axle to the plurality of main beams.
